(19) United States
(12) Patent Application Publication
(10) Pub. No.: US 2003/0098694 A1
(43) Pub. Date: May 29, 2003

(54) Insulation diagnosis device

(76) Inventors: Yasunobu Fujita, Hitachi (JP); Naoki Kawamura, Hitachi (JP)

Correspondence Address: MATTINGLY, STANGER & MALUR, P.C., Suite 370, 1800 Diagonal Road, Alexandria, VA, 22314, US

(21) Appl. No.: 10/078,400

(22) Filed: Feb. 21, 2002

(30) Foreign Application Priority Data
Nov. 28, 2001 (JP) 2001-362290

(51) Int. Cl. H04B 3/46; H01H 31/02

(52) U.S. Cl. 324/541

(57) ABSTRACT

An insulation diagnosis device for diagnosing insulation deterioration in a non-grounded type electric power distribution system provided with a computation processing unit which calculates an intermittent flash grounding and which is inputted of zero phase voltages and line voltages and includes a peak hold processing unit, a peak hold reset processing unit and a phase region detection and processing unit. Thereby, an insulation diagnosis device is provided which can always diagnose insulation deterioration safely under actual use condition without stopping the concerned electric power installation, and, at the time of intermittent flash grounding occurrence, can specify existence and non-existence of grounding occurrence before activation of a protective relay.

### BACKGROUND OF THE INVENTION

1. Field of the Invention

The present invention relates to an insulation diagnosis device for power transmission lines and, in particular, relates to an insulation diagnosis device which always diagnoses insulation properties of electrical machines and apparatuses and judges deterioration tendency before advancing to a significant accident due to insulation deterioration.

2. Conventional Art

An insulation deterioration of an electrical installation develops depending on time and finally results in such as a grounding accident and a shorting accident frequently. Although the mechanism of insulation deterioration developement is complex, roughly speaking, the following two cases of mode are common.

In a first case, a current leakage begins from such as flaws and deterioration portions at such as cable coatings and conductor supporting insulators and the flaws and deterioration portions develope due to such as heat, pressure and ions caused by the leakage current which further increases the leakage current.

In another case, as observed in a case of cables, water penetrates into an insulating material in a tree shape to cause at once a dielectric breakdown, and thereafter the insulation is restored.

The later case is called as an intermittent flash grounding, and the phenomenon terminates in a very short time and shows no reproducibility, therefore, the detection thereof was very hard.

However, a recent electrical installation requires a technology which permits to detect such intermittent flash grounding current under active line condition and further requires a predictive diagnosis technology which permits scheduling of planed installation stop.

Conventionally, a switchgear was provided between a neutral point of a grounding potential transformer (herein after will be called as GPT) and the ground, and during normal operation the switchgear was closed. When performing an insulation diagnosis, the switchgear is opened and a DC voltage is applied between the both opened electrodes of the switchgear to measure a leakage current from the concerned electrical installation to the ground. When the measured result exceeds a predetermined reference value, the electric installation was stopped to detect insulation deterioration of individual power lines. However, even if cables are judged abnormal through measurement with such device, some of them can still be used practically with no problem, and on the other hand, some of the cables judged as normal showed abnormality under actual use. The reasons of such misjudgment are difference of the measurement condition, in that measurement with DC voltage instead of AC voltage under the actual use and a delicate difference of the applied voltage.

Further, JP-A-4-42726 (1992) discloses to extract a grounding signal through detection of a reference line voltage signal and respective line voltage signals for other two phases and zero phase current and to judge the grounding section through detection of the grounding phase from the phase of the extracted grounding signal. However, with such measure, it is necessary to detect the zero phase current for respective lines, therefore, it is necessary to dispose such measures for every line depending on the line number increase.

In the conventional art, because of error due to the DC voltage application which is different from the actual use AC voltage, there was a drawback that the judgement result did not necessarily meet the actual use condition. Further, at the time of grounding accident occurrence a high voltage is generated between the GPT neutral point and the ground, it was impossible to perform measurement by disposing always the insulation diagnosis device, but was required to limit to perform the diagnosis periodically for a short time, therefore, the detection of intermittent flash grounding was difficult.

### SUMMARY OF THE INVENTION

An object of the present invention is to provide an insulation diagnosis device which can always diagnose insulation deterioration safely under actual use condition without stopping the concerned electric power installation, and, at the time of intermittent flash grounding occurrence, can specify existence and non-existence of grounding occurrence before activation of a protective relay.

The above object can be achieved by an insulation diagnosis device for diagnosing insulation deterioration in a non-grounded type electric power distribution system which is provided with a computation processing unit which calculates an intermittent flash grounding which is inputted of zero phase voltages and line voltages and includes a peak hold processing unit, a peak hold reset processing unit and a phase region detection and processing unit.

Now, as has been explained in connection with the conventional art, the insulation deterioration in electric installations is roughly classified into two cases.

(1) In the first case in which a current leakage begins from such as flaws and deterioration portions at such as cable coatings and conductor supporting insulators, and the flaws and deterioration portions develope due to such as heat, pressure and ions caused by the leakage current which further increases the leakage current, when taking up an example of non-grounded type power distribution system wherein an induced voltage in the tertiary winding of a grounding transformer at the time of complete grounding thereof is assumed as 190V, and if the zero phase voltage thereof is noted, the following relationships between installation conditions and zero phase voltages as indicated in Table 1 are obtained.

TABLE 1

| | | | conventional | | | | |
|---|---|---|---|---|---|---|---|
| | | | art | | present invention | | |
| | instal- | zero | | deteri- | | deterio- | |
| | lation | phase | protec- | oration | protec- | ration | |
| | condi- | volt- | tive | detec- | tive | detec- | technical |
| No | tion | age | relay | tion | relay | tion | problems |
| 1 | normal | 0 V | not | not | not | not | |
| | | | acti- | done | acti- | activat- | |
| | | | vated | | vated | ed | |
| 2 | normal | 0-10 V | not | not | not | not | influence |
| | | | acti- | done | acti- | activat- | of cable |
| | | | vated | | vated | ed | stray |
| | | | | | | | capaci- |
| | | | | | | | tance to |
| | | | | | | | ground |
| 3 | unsta- | 10- | not | not | not | activat- | signifi- |
| | ble | 40 V | acti- | done | acti- | ed | cant |
| | | | vated | | vated | | accident |
| | | | | | | | sign |
| 4 | abnor- | 40- | acti- | not | acti- | activat- | accident |
| | mal | 190 V | vated | done | vated | ed | |

In order to detect the state NO.3 in Table 1 without fail, it is preferable to use the following measures;

1) Amplification of zero phase voltage so as to increase detection sensitivity,

2) Addition of a bandpass filter so as to suppress induced noises,

3) Designation of an operating region so as to prevent erroneous operation, and

4) Setting of time limit so as to prevent unwanted operation.

(2) In the second case, as observed in a case of cables, in that water penetrates into an insulating material in a tree shape to cause at once a dielectric breakdown, and thereafter the insulation is restored, the following measures are provided;

1) A peak hold circuit which is available in the processing unit, because the zero phase voltage generation is a short time phenomenon,

2) A reset circuit for the zero phase voltage peak hold,

3) A computation processing unit of the zero phase voltage peak hold signal and the phase voltage, and

4) A computing circuit for discriminating a deterioration phase.

According to the present invention, the above object can be achieved by the following principle.

Generally, in an electric power transmission system, since a zero phase voltage is induced when the three phase voltages unbalance, therefore, if a zero phase voltage can be detected, an abnormality in the system can be determined. With regard to the intermittent flash grounding, the duration of the grounding is short, however, the voltage thereof shows high frequencies and the peak voltage thereof is characterized by being substantially the same as the peak voltage value at the time of complete grounding. Accordingly, if a peak voltage of high frequencies is detected, an existence and absence of an intermittent flash grounding can be detected.

Further, after amplifying a very small zero phase voltage and passing the same through a bandpass filter for removing noises, the resultant waveform is continuously monitored and compared with classified zero phase voltages in n steps as defined in advance which are caused because of insulation deterioration, thereby, the insulation condition can always be diagnosed.

### BRIEF DESCRIPTION OF THE DRAWINGS

FIG. 1 shows an embodiment of the present invention, and is a diagram for explaining a layout structure of an electrical installation provided with an insulation diagnosis device;

FIG. 2 is a diagram showing an intermittent flash grounding detection processing unit representing one embodiment of the present invention;

FIG. 3 is a diagram showing a small grounding current detection processing unit representing one embodiment of the present invention;

FIG. 4 is a diagram for explaining an operation phase region representing one embodiment of the present invention; and

FIG. 5 is a diagram for explaining an intermittent flash grounding detection of the present invention.

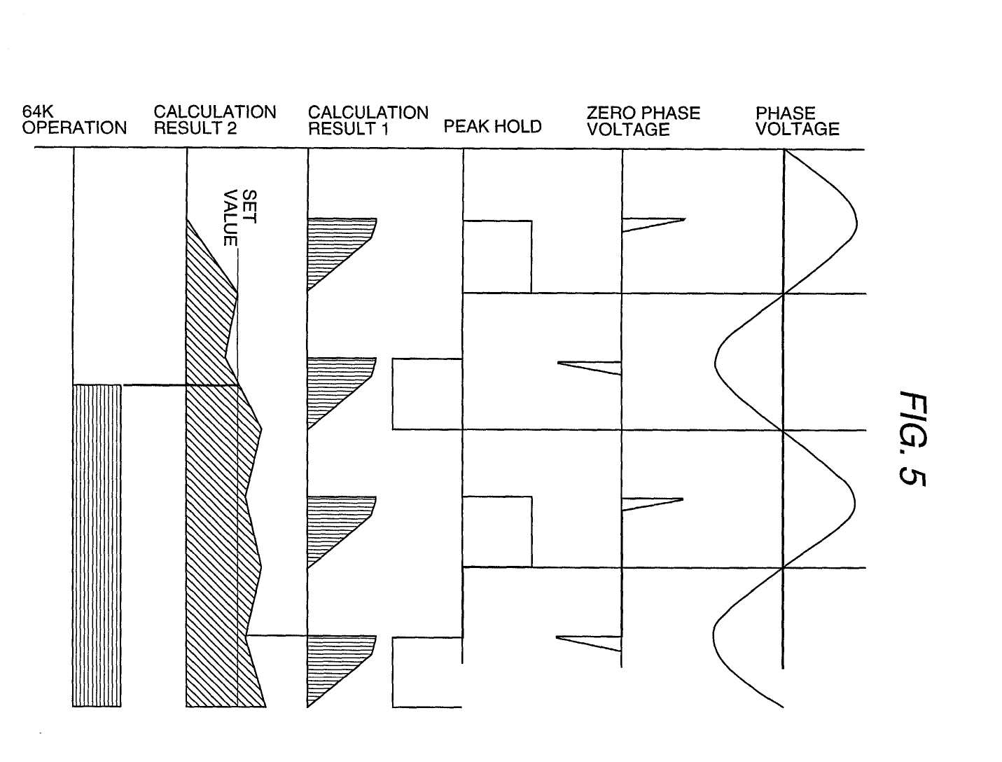

### DETAILED DESCRIPTION OF THE EMBODIMENTS

Hereinbelow, embodiments of the present invention will be explained with reference to the drawings.

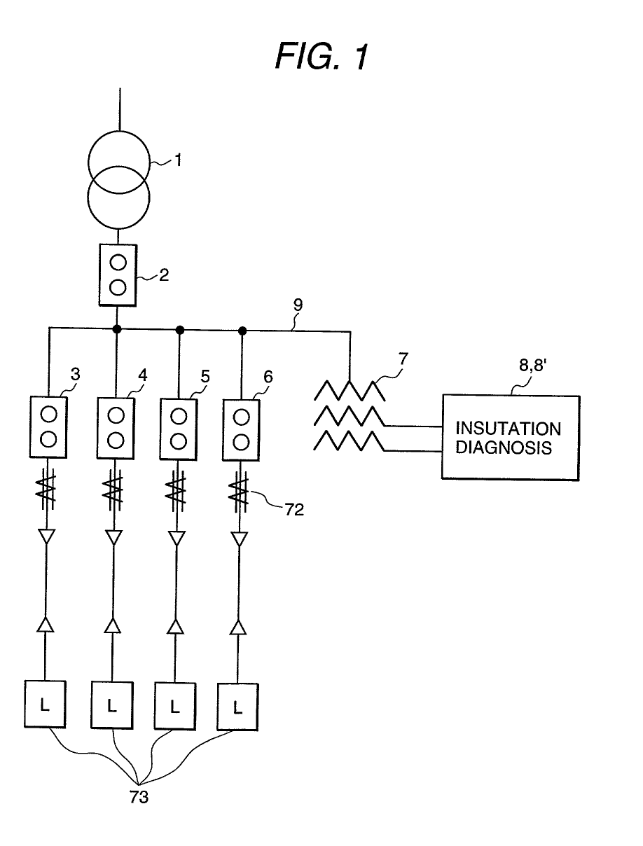

FIG. 1 is a diagram for explaining a layout structure of an electrical installation provided with an insulation diagnosis device according to the present invention.

The objective electrical installation as shown in the drawing is an installation for high voltage power distribution system, and is constituted by a circuit breaker 2 connected to a transformer 1, a bus line 9 connected to the circuit breaker 2, a plurality of feeder use circuit breakers 3 through 6 and a grounding transformer 7 which are led out from the bus line 9 and zero phase current transformers 72 and loads 73 which are respectively disposed for every phase. An insulation diagnosis device 8 takes in from the grounding transformer 7 zero phase voltages and line voltages as its input signals. The reasons for taking in the line voltages are as follows;

1) When a grounding occurs, a distortion is caused in a phase voltage waveform. At the time of complete grounding, the concerned phase voltage assumes “0V”.

2) Even at the time of grounding occurrence, the line voltage is neither suffered from waveform disturbance nor reduces to “0V”.

3) Because of the above 1) and 2), in order to perform such as phase comparison, the line voltage is more advantageous as a reference voltage.

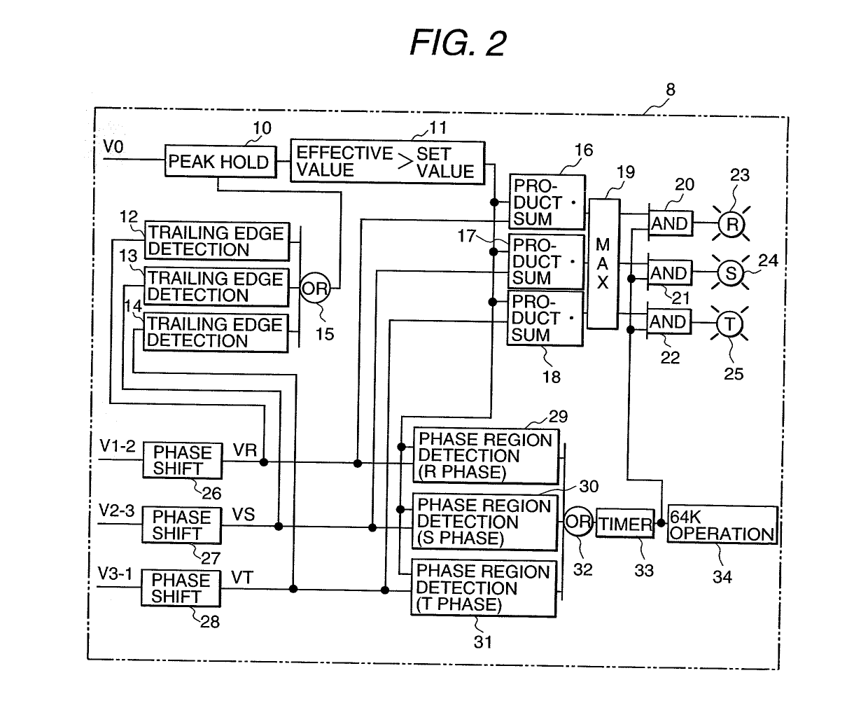

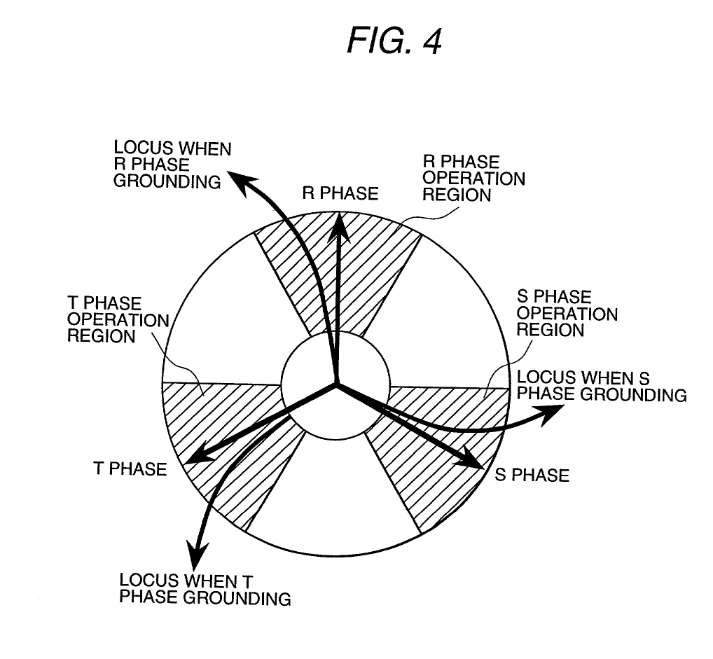

FIG. 2 shows an inner structure of the insulation diagnosis device in which a high frequency voltage in the zero phase voltage from the grounding transformer 7 is converted at a peak hold circuit 10, the converted value is computed and compared at an effective value computation and set value comparison unit 11, and when the effective value is more than the set value, a total sum of product of the line voltage and the phase voltages (R phase, S phase and T phase) converted at phase shift circuits 26 through 28 is computed at total sum product processing units 16 through 18, the computed results are subjected to comparison computation at the maximum value computation unit 19, and the result thereof is subjected to AND computation together with the computation result for a 64K operation processing unit 34 at AND circuits 20 through 22, and the computation results for every operation phase (R phase, S phase and T phase) are displayed at displays 23 through 25. In the peak-hold computing unit, the peak hold circuit 10 is reset by a signal from an OR circuit 15 which performs an OR operation on computation results from trailing edge computation units 12 through 14 which receive phase voltages converted from line voltages by phase shift computation units 26 through 28. The reason for resetting the peak hold circuit 10 with the trailing edges after the line voltages being converted into the phase voltages is that the computation result (product and sum computation of the phase voltage and the peak hold value) shows the maximum sensitivity when the peak hold circuit 10 is set at the trailing edge of the phase voltages and the sensitivity of the computation results reduces by resetting at both before and after the trailing edge of the phase voltages. On the other hand, the computation result of the effective value computation and set value comparison unit 11 and the phase voltages of R phase, S phase and T phase are compared and computed at phase region computing units 29 through 31, and when the computation result matches with the regions shown in FIG. 4, the computation result is transmitted to the 64K operation processing unit 34 via an OR circuit 32 and a timer 33.

When the computations are performed with the above circuit structure, a high frequency zero phase voltage which is generated at the time of intermittent flash grounding can be surely detected. Further, according to the inventor's experimental result, it was observed that the intermittent flash grounding phenomena having duration of 0.1-0.5 sec. frequently occur, but no intermittent flash grounding phenomena having duration more than 5 sec. were observed. Therefore, the setting time of the timer 33 is important and the setting time of 0.1-1.0 sec. is effective. On the other hand, with regard to deterioration phenomenon by a tree shape water penetration, water penetrates in a gap of an insulator deteriorated in a tree shape to cause a grounding and the water is evaporated by the grounding current to thereby restore the insulation, however, the gap portion is slightly enlarged and water is again penetrated into the gap and another grounding is caused which is repeated. Time interval from one grounding to another is shortened through repetition of such groundings. Therefore, the insulation diagnosis device includes a time management function and predicts a subsequent grounding occurrence estimation time (T3) according to the following equation;

T3=(T2−T1)×K

wherein, T1 is previous grounding occurrence time, T2 is the instant grounding occurrence time and K is coefficient of 0.3-0.7.

In view of the subsequent grounding occurrence estimation time, a maintenance person or persons of the electric installation performs a repair work rapidly or plans a repairment schedule according to the estimated time.

On the other hand, a small grounding phenomenon which is caused by accumulation of salt and dusts on the bus line 9, bushings and supporting insulators is detected by an insulation diagnosis device 8′.

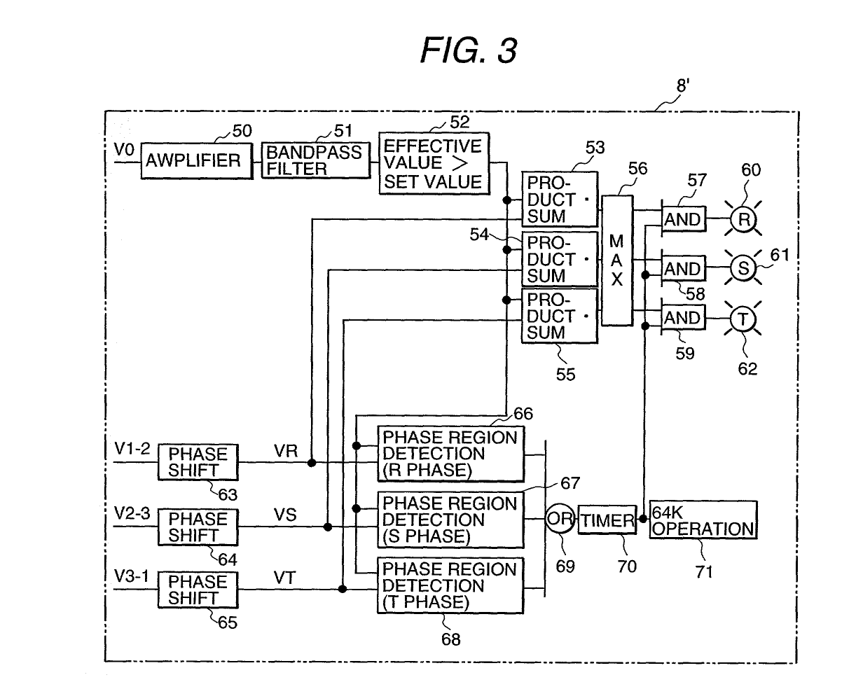

The insulation diagnosis device 8′ takes in as its input signals the zero phase voltages and line voltages from the grounding transformer 7. FIG. 3 shows an internal structure of the insulation diagnosis device 8′. At the time of a small grounding since a region of a small waveform component of the fundamental frequency has to be dealt, a bandpass filter 51 having a performance of about Q=5 when placing the fundamental frequency at the center is required. The zero phase voltage signals are inputted to an effective value computation and set value comparison unit 52 after the same are amplified to a predetermined level by an amplifier 50 and the fundamental frequency component is extracted through the bandpass filter 51. The input signals are computed and compared at the effective value computation and set value comparison unit 52, and when the effective value is more than the set value, a total sum of product of the line voltage and the phase voltages (R phase, S phase and T phase) converted at phase shift processing units 63 through 65 is computed at total sum product processing units 53 through 55, the computed results are subjected to comparison computation at a maximum value processing unit 56, and the result thereof is subjected to AND computation together with the computation result for a 64L operation processing unit 71 at AND circuits 57 through 59, and the computation results for every operation phase (R phase, S phase and T phase) are displayed at displays 60 through 62. On the other hand, the computation result of the effective value computation and set value comparison unit 52 and the phase voltages of R phase, S phase and T phase are compared and computed at phase region computing units 66 through 68, and when the computation result matches with the regions shown in FIG. 4, the computation result is transmitted to the 64L operation processing unit 71 via an OR circuit 69 and a timer 70. At the time of small grounding occurrence, the grounding resistance is large and occupies a major component in the impedance, thus, the zero phase voltage assumes substantially the same phase as the phase voltage, therefore, the operation region as shown in FIG. 4 is effective for preventing an erroneous operation. In addition such small grounding is not required to be detected quickly, it is sufficient if the confirming time of the timer 70 is set at about 60 sec or more than that.

According to the present invention diagnosis of insulation deterioration can always be performed safely under line activating condition without stopping the concerned electric power installation, and, at the time of intermittent flash grounding occurrence existence and absence of grounding occurrence can be specified before activation of a protective relay.

1. An insulation diagnosis device for diagnosing insulation deterioration in a non-grounded type electric power distribution system comprising a computation processing unit which calculates an intermittent flash grounding and which is inputted zero phase voltages and line voltages and includes a peak hold processing unit, a peak hold reset processing unit and a phase region detection and processing unit.

2. An insulation diagnosis device of claim 1, further comprises a computation and processing unit which calculates a small grounding and which is inputted of zero phase voltages and line voltages and includes an amplifier, a bandpass filter processing unit and another phase region detection processing unit.

3. An insulation diagnosis device of claim 1 or 2, wherein a timer which performs operation confirmation of an intermittent flash grounding is further provided and time of the timer is set at 0.1-1.0 sec.

4. An insulation diagnosis device of any one of claims 1 through 3, wherein time of intermittent flash grounding occurrence is stored and a subsequent intermittent grounding occurrence time is estimated based on the interval from the previous intermittent flash grounding occurrence time to the instant one.

5. A high voltage electric power distribution system installation which is provided with any one of insulation diagnosis devices as defined in claims 1 through 4.
